(19) United States
(12) Patent Application Publication
(10) Pub. No.: US 2009/0006316 A1
(43) Pub. Date: Jan. 1, 2009

(54) Methods and Apparatus for Rewriting Regular XPath Queries on XML Views

(76) Inventors: Wenfei Fan, Wayne, PA (US); Floris Geerts, Edinburgh (GB); Xibei Jia, Edinburgh (GB); Anastasios Kementsietsidis, Edinburgh (GB)

Correspondence Address: Ryan, Mason & Lewis, LLP, Suite 205, 1300 Post Road, Fairfield, CT, 06824, US

(21) Appl. No.: 11/771,095

(22) Filed: Jun. 29, 2007

(51) Int. Cl. G06F 7/00

(52) U.S. Cl. 707/2; 707/3; 707/E17.014

(57) ABSTRACT

Methods and apparatus are provided for rewriting view queries into equivalent queries on the source document. According to one aspect of the invention, methods are provided for processing a view query on a database view. The method comprises the steps of translating the view query to a mixed finite state automata representation of a document query on one or more documents underlying the database view; and evaluating the document query on the one or more documents to obtain a result to the view query. The view query may be, for example, a regular XPath query.

### FIELD OF THE INVENTION

The present invention relates generally to XML query techniques, and mole particularly, to methods and apparatus for rewriting view queries into equivalent queries on the source document.

### BACKGROUND OF THE INVENTION

In many applications, users can access an XML document only by querying a view of the data in order to enforce access control on the underlying XML data. To prevent improper disclosure of sensitive or confidential information of XML data residing in a server, the server defines an XML view for each group of users, consisting of all and only the information that the users are authorized to access. While the users may query the view, they are not allowed to directly query or access the underlying document (referred to as the source).

It is often necessary to answer queries posed on the views. A number of techniques have been proposed or suggested that first materialize the views and then directly evaluate queries on the views. It is often too costly, however, to materialize and maintain a large number of views, a common scenario when many groups of users with different access privileges query the same source. A more realistic approach is to rewrite the queries on the views into equivalent queries on the source, and then to evaluate the rewritten queries on the source, and return the answers to one or more users.

A need therefore exists fox improved methods and apparatus for rewriting view queries into equivalent queries on the source. Yet another need exists for improved methods and apparatus for evaluating the rewritten queries on the source, and then returning the result to one or more users.

### SUMMARY OF THE INVENTION

Generally, methods and apparatus are provided for rewriting view queries into equivalent queries on the source document. According to one aspect of the invention, methods ate provided for processing a view query on a database view. The method comprises the steps of translating the view query to a mixed finite state automata representation of a document query on one or more documents underlying the database view; and evaluating the document query on the one or mote documents to obtain a result to the view query. The view query may be, for example, a regular XPath query.

The disclosed mixed finite state automata is a nondeterministic finite automaton in which a state may be annotated with an alternating finite state automaton. The nondeterministic finite automaton captures selecting paths of the view query that extract and return nodes from the database. The alternating finite state automaton characterizes filters in the view query that constrain an extraction of nodes from the database.

The translating step generates one or mote local translations for one or more sub-queries for the view query and one or more element types in the database view. Generally, the evaluating step traverses a tree associated with the one or more documents using a top-down, depth-first analysis, wherein the mixed finite state automata prunes away one or more irrelevant subtrees and identifies one or more alternating finite state automata that need to be evaluated at nodes in the tree.

Visited nodes from the tree can be stored in a stack that is used to evaluate the alternating finite state automata in a synthesized, bottom-up manner. A node is removed from the stack once the alternating finite state automata related to the node have been evaluated. An auxiliary data structure can store one or more candidate answers. An index structure optionally allows one or more subtrees to be skipped.

A more complete understanding of the present invention, as well as further features and advantages of the present invention, will be obtained by reference to the following detailed description and drawings.

### BRIEF DESCRIPTION OF THE DRAWINGS

FIGS. 1(a) through 1(c) illustrate exemplary document and view DTDs and view specification;

FIG. 2 is a table summarizing the closure property and complexity of XPath and regular XPath query rewriting;

FIG. 3 illustrates a nondeterministic finite automaton (NFA) “annotated” with alternating finite state automata (AFA) in accordance with example 4.1;

FIG. 4 illustates an evaluation of a mixed finite state automata in accordance with the present invention;

FIGS. 5(a) through 5(c) illustrate the rewriting of an exemplary query to a corresponding mixed finite state automata in accordance with the present invention;

FIG. 6 illustrates exemplary pseudocode for an implementation of a hybrid pass evaluation process and a related procedure, both incorporating features of the present invention;

FIG. 7 is a table illustrating the evaluation of an mixed finite state automata M₀ on a tree T by the HyPE process of FIG. 6; and

FIG. 8 is a block diagram of a system that can implement the processes of the present invention

### DETAILED DESCRIPTION

The present invention provides methods and apparatus for answering regular XPath queries posed on possibly recursively defined XML views Query rewriting is performed using mixed finite state automata as an intermediate representation of rewritten regular XPath queries. According to one aspect of the invention, an algorithm is provided for rewriting regular XPath queries on XML views to equivalent MFA on the source. Another aspect of the invention provides an evaluation algorithm for mixed finite state automata. These aspects of the invention yield an effective method for answering queries posed on XML views of XML data, and are useful in enforcing XML security, among other things.

Rewriting Problem

The present invention recognizes XML queries posed on virtual XML views can be rewritten into equivalent queries on the underlying XML document. For XML queries, a fragment of XPath can be employed, which supports recursion (the descendant-or-self axis “//”), union and complex filters (predicates). This class of XPath queries is commonly used in practice and is essential to XQuery, XSLT and XML Schema. XML views are considered that are defined by annotating a view DTD with a collection of (regular) XPath expressions, along the same lines as how commercial systems specify XML views. An XML view defined as above is a mapping σ:D→D_{V} in the global-as-view style, from XML documents of the document DTD D to documents of the view DTD D_{V}. When the view schema D_{V} is recursively defined, i.e., if some element type in D_{V} is defined in terms of itself, so is the view.

The rewriting problem is to find an algorithm that, given a view definition σ and an XPath query Q over the view DTD D_{V}, computes an XPath query Q′ over the document DTD D such that for any XML tree T of D, Q(σ(T))=Q′(T)

While there has been a host of work on rewriting XPath queries into SQL queries for XML views of relational data (see R. Krishnamoorthy et al., “Recursive XML Schemas, Recursive XML Queries and Relational Storage: XML-to-SQL Query Translation,” ICDE (2004) for a survey), little previous work has considered rewriting XPath queries into XPath queries for XML views of XML data. In this context, query rewriting has only been studied for non-recursive XML views, over which XPath rewriting is always possible. However, query rewriting for recursive views is still an open problem.

Recursive DTDs naturally arise when, e.g., specifying biomedical data (see the Gene Ontology database, GO); in fact it has been shown that out of 60 real-world DTDs analyzed, more than half (35) of them were recursive. It is the reason that Oracle supports fully recursively defined XML views and that IBM also allows a class of recursively defined XML views. However desirable, the rewriting problem is more intriguing for recursively defined views, due to the interaction between recursion in XPath queries (e.g., “//”) and recursion in the view definition.

### EXAMPLE 1.1

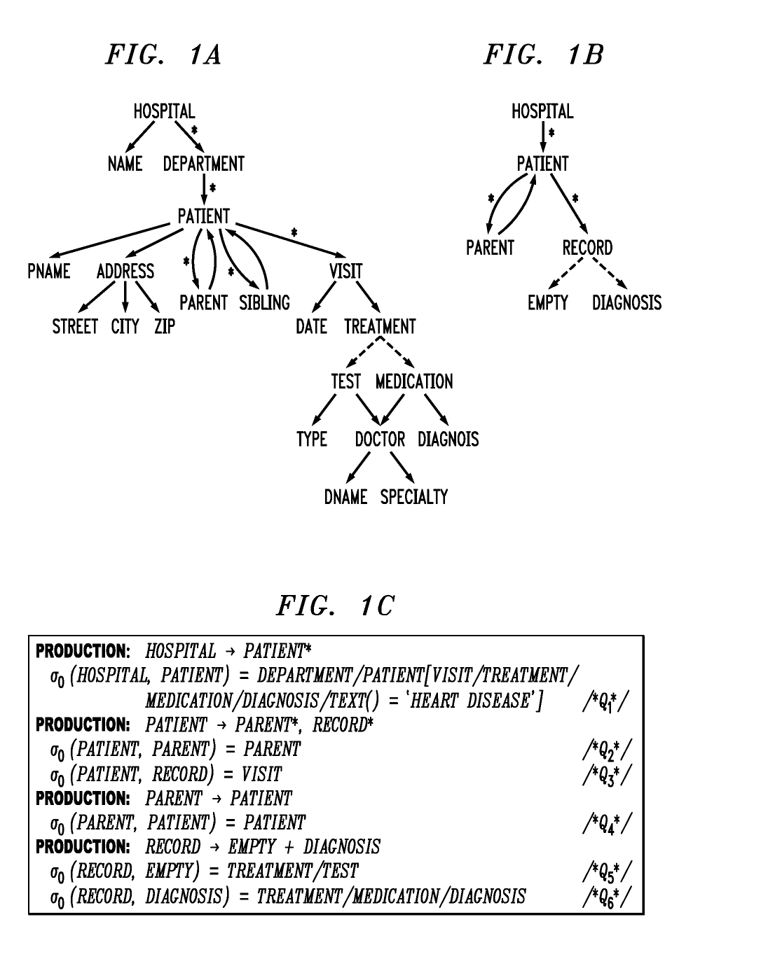

Consider a hospital DTD D shown as a graph in FIG. 1(a) A hospital document of D consists of a list of departments, and each department has a list of in-patients (i.e., patients who are currently residing in the hospital; “*” is used on an edge to indicate a list). For each patient, the hospital maintains her name (pname), address, records of visits, each including the visit date and treatment that is either a test or some medication (dashed edges indicate disjunction), as well as information about the treating doctor. Each name, pname, street, city, zip, date, type, dname, specialty has a single text node (PCDATA) as its child (omitted in FIG. 1(a)). The hospital also maintains family medical history by means of the recursively defined parent and sibling. It records the same information of ancestors with those of in-patients, by sharing the description for patients.

A view σ₀ is defined for a research institute studying inherited patterns of heart disease, with the view DTD depicted in FIG. 1(b) (the view is defined in Example 2.2). Obliged by the Patient Privacy Act, the view reveals only those patients who have heart disease, along with their parent hierarchy. While the institute may access diagnosis information of those patients and their ancestors, it is denied access to their name, address, test and doctor data.

Consider an XPath query Q posed on the view, which is to find patients whose ancestors also had heart disease:

Q: patient[*//record/diagnosis/text( )=heartdisease′]

Here * denotes a wildcard, i.e., any element. However, it is impossible to rewrite Q on the view to an equivalent query (in the XPath fragment mentioned above) on the underlying hospital document. This is because “//” in Q is supposed to traverse only the parent hierarchy on the view, i.e., a sequence of the (parent/patient) pattern; however; when translated to a query Q′ on the source, Q′ necessarily retains “//” since the view DTD is recursive, and “//” in Q′ may access siblings of those patients, although siblings are not in the view and are not allowed to be accessed. An incorrect translation may lead to a serious security breach.

In response to this, both fundamental results and practical techniques are developed for the rewriting problem.

Closure Properties

On the theoretical side, the closure property of XPath under query rewriting is addressed by the present invention: is it always possible to rewrite XPath queries on views to XPath queries on the source? It is shown that XPath is not closed under query rewriting for recursive views. In light of this, a mild extension of XPath, regular XPath is considered, that uses the general Kleene closure E* instead of the “//” axis. It is shown that regular XPath is closed under rewriting for arbitrary views, recursive or not. Since regular XPath subsumes XPath, any XPath queries on views can be rewritten to equivalent regular XPath queries on the source.

However, the rewriting problem is EXPTIME-complete: for a (regular) XPath query Q over even a (non-)recursive view, the rewritten regular XPath query on the source may be inherently exponential in the size of Q and the view DTD D_{V}. This tells us that rewriting is beyond reach in practice if Q is directly rewritten into regular XPath.

On the practical side, to avoid the exponential blow-up, the following techniques are disclosed for answering (regular) XPath queries posed on XML views.

Automaton-Based Rewriting for (Regular) XPath

A rewriting method is disclosed based on a notion of mixed finite state automata (MFA) to represent rewritten regular XPath queries. An MFA is a nondeterministic finite automaton (NFA) “annotated” with alternating finite state automata (AFA), which characterize data-selection paths and filters of a regular XPath query Q, respectively. The algorithm rewrites Q into an equivalent MFA M. In contrast to the exponential blowup, the size of M is bounded by O(|Q∥σ∥D_{V}|). This makes it possible to answer queries on views via rewriting. Although a number of automata formalisms were proposed for XPath and XML stream, they cannot characterize regular XPath queries, as opposed to MFA.

Evaluation of Rewritten Query

An efficient algorithm is also disclosed for evaluating MFA M (rewritten regular XPath queries) on XML source T. While there have been a number of evaluation algorithms developed for XPath, none is capable of processing regular XPath queries. Previous algorithms for XPath require at least two passes of T: a bottom-up traversal of T to evaluate filters, followed by a top-down pass of T to select nodes in the query answer. In contrast, the disclosed evaluation algorithm combines the two passes into a single top-down pass of T during which it both evaluates filters and identifies potential answer nodes. The key idea is to use an auxiliary graph, often far smaller than T, to store potential answer nodes. Then, a single traversal of the graph suffices to find the actual answer nodes. The algorithm effectively avoids unnecessary processing of subtrees of T that do not contribute to the query answer. It is an efficient algorithm for evaluating regular XPath queries (MFA), and provides an efficient (alternative) algorithm to evaluate XPath queries.

XPath and Regular XPath

A class of regular XPath queries is considered that were proposed and studied in M. Marx, “XPath With Conditional Axis Relations,” EDBT (2004), denoted by X_{reg} and defined as follows:

Q::=ε|A|Q/Q|Q∪Q|Q*|Q[q],

q::=Q|Q/text( )=‘c’ [symbol] Q|Q̂Q|Q [symbol] Q

where ε is the empty path (self), A is a label (tag), “∪” represents union, “/” is the child-axis, and * is the Kleene star; [q] is referred to as a filter, in which Q is an X_{reg} expressions, c is a string constant, and [symbol] ,̂, [symbol] ate the Boolean negation, conjunction and disjunction, respectively Regular XPath extends regular expressions by allowing filters, and extends XPath by supporting Kleene closure Q* as opposed to the restricted recursion “//” (the descendant-or-self axis). See also, W. Fan et al., “Rewriting Regular Xpath Queries On XML Views,” Int'l Conf. on Data Engineering (2007), incorporated by reference herein.

Like XPath queries, when an X_{reg} query Q is evaluated at a node v in an XML tree T, it returns the set of nodes of T reachable via Q from v, denoted by v∥Q∥. An XPath fragment of X_{reg} is also considered, denoted by X, which is defined by replacing Q* with “//” in the definition above. Note that given a DTD D of the documents on which queries are posed, “//” is expressible in X_{reg} as ( [symbol] Ele)*, where [symbol] Ele denotes the union of all the labels in D

### EXAMPLE 2.1

Consider an XML document T conforming to the document DTD D in FIG. 1(a). The following regular XPath query:

Q=hospital/department/patient[q₀ [symbol] (q₁/(q₁)*)]/pname

q₀=visit/treatment/medication/diagnosis/text( )=“heart disease”

q₁=parent/patient[ [symbol] q₀]/parent/patient[q₀]

when evaluated on T, returns the names of patients who have heart disease and the disease appears in their ancestors but always skips a generation. Such queries, which look for certain patterns, are often encountered in medical research. Note that the query is in the fragment X_{reg}, but is not expressible in the XPath fragment X.

Regular XPath queries are considered with only downward modalities since they are most commonly used in practice. As will be seen shortly, rewriting queries is already challenging in this setting. It is thus necessary to understand rewriting of these basic queries before dealing with full-fledged XPath or XQuery.

DTD

A DTD D is represented as a triple (Ele,P,r), where Ele is a finite set of element types; r is a distinguished type in Ele, called the root type; P defines the element types: for each A in Ele, P(A) is a regular expression of the form: str, ε, B₁, . . . , Bₙ, or B₁+ . . . +Bₙ. Here, str denotes PCDATA, ε is the empty word, B₁ is either B or of the form B* where B is in Ele (referred to as a child type of A), and “+”, “,” and “*” denote disjunction (with n>1), concatenation and the Kleene star, respectively A→P(A) is referred to as the production of A. This form of DTD's does not lose generality since any DTD can be converted to a DTD of this form by using new element types.

A DTD can be represented as a graph, as shown in FIG. 1. It is recursive if the corresponding graph is cyclic. For example, both DTD's depicted in FIG. 1 are recursive.

XML Views

Views can be defined by annotating a DTD. This is similar in spirit to XML view specification in commercial systems, e.g., annotated XSD's (AXSD) in OracleXML DB and Microsoft SQLServer 2000 SQLXML, and Document Access Definitions (DAD) of IBM DB2 XML Extender. Specifically, an XML view is defined as a mapping σ:D→D_{V}, where D is a document DTD, D_{V} is a viewDTD. Given an XML document T of D, the mapping generates an XML view σ(T) that conforms to the view DTD D_{V}. More specifically, for each element type A and its child type B in D_{V} (i.e., each edge (A, B) in the DTD graph of D_{V}), σ maps (A, B) to a query σ(A, B) defined on documents T of D. Intuitively, given an A element, σ(A, B) generates its B children in the view by extracting data from T. The query σ(A, B) is in the regular XPath fragment X_{reg} given above. The XML view is recursive if the view DTD D_{V} is recursive.

### EXAMPLE 2.2

FIG. 1(c) defines the view σ₀ described in Example 1.1. The semantics of σ₀, informally presented, is as follows: Given a hospital document T, σ₀ generates a view σ₀(T) top-down, which conforms to the view DTD of FIG. 1(b). The query Q₁ (i.e., σ₀(hospital, patient)) extracts from T those patients who have heart disease. For the patients extracted by Q₁, (a) Q₂ finds their parent nodes, which are in turn processed by Q₄ and then inductively by Q₂ and Q₃ to form the parent hierarchy, and (b) Q₃ finds the record (i.e., visit) data, which can be either be empty (i.e., test) or diagnosis, handled by Q₅, Q₆, respectively.

### The Closure Property of (Regular) XPath

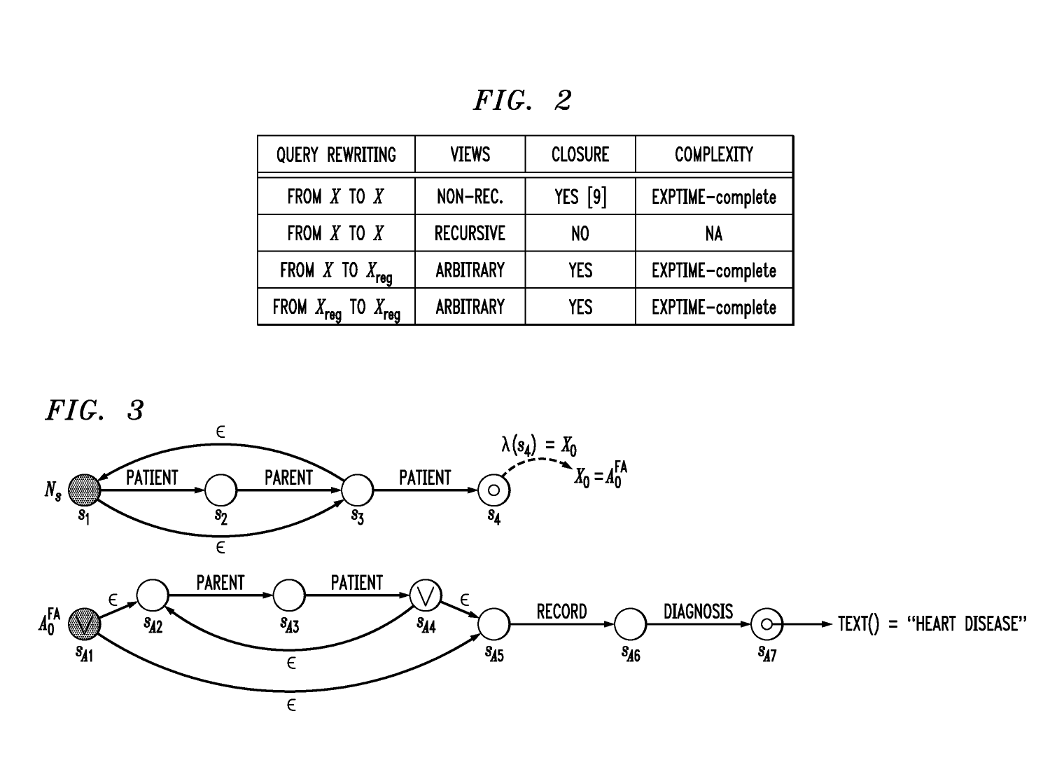

FIG. 2 summarizes the closure property and complexity of XPath and regular XPath query rewriting.

Formally, an XML query language L is closed under rewriting if there exists a computable function F:L→L that, given any view definition σ:D→D_{V} and any query Q in L over D_{V}, computes query Q′=F(Q) in L such that for any document T of D, Q(σ(T))=Q′(T). While one may consider translating an XPath query Q to an equivalent Q′ in a richer language, e.g., XQuery or XSLT, it is vastly preferable to have an XPath translation since it is more efficient to evaluate XPath queries than queries in the aforementioned Turing-complete languages. The closure property is desirable since rewriting should not be penalized by paying the higher price for evaluating and optimizing queries in a richer language than that of the original query.

It has been shown that the class X of XPath queries defined above is closed under query rewriting for non-recursive views. However, below it is shown that in the presence of recursion in a view definition, this is no longer the case (even when the annotating queries are in X).

It has been found that for recursively defined XML views, the fragment X is not closed under query rewriting. In contrast, the fragment X_{reg} of regular XPath given in the last section is closed under query rewriting. For arbitrary XML views (recursive or non-recursive), X_{reg} is closed under rewriting.

### EXAMPLE 3.1

Recall the view σ:D→D_{V} defined in Example 2.2 and the query Q given in Example 1.1. Using the queries Q₁, Q₂, Q₃, Q₄ and Q₆ from the view specification in FIG. 1(c), a correct rewriting Q′ of query Q can be computed. Specifically: Q′=Q₁[Q₂/Q₄/(Q₂/Q₄)*/Q₃/Q₆/text( )=‘heart disease’]. For any document T that conforms to D, Q′(T)=Q(σ₀(T)).

Although it is always possible to rewrite a (regular) XPath query on a view to an equivalent regular XPath query on the source, it is often prohibitively expensive if it is to directly compute X_{reg} queries as output. Indeed, the rewriting problem subsumes the problem for translation from NFA's to regular expressions. The latter problem is EXPTIME-complete: the size of the explicit representation of a regular expression is exponential in the size of the NFA. Worse still, it remains exponential even if the NFA is acyclic.

Corollary 3.3: There exist a view definition σ:D→D_{V} and a query Q in X such that for any Q′ in X_{reg}, if Q(σ(T))=Q′(T) fox all XML trees T of D, then the size |Q′| of Q′, when represented as an X_{reg} query, is exponential in |Q| and the size |D_{V}| of D_{V}. The lower bound remains intact even when D_{V} is non-recursive

### Mixed Finite State Automata

The exponential lower bound of Corollary 3.3 indicates that a direct rewriting into (regular) XPath is beyond reach in practice. To overcome this, a new representation of X_{reg} queries is provided, referred to as mixed finite state automata (MFA). Along the same lines as NFA for regular expressions, MFAs characterize X_{reg} queries and avoid the exponential blowup of rewriting. Leveraging MFA, a practical solution is provided to the rewriting problem by providing (a) a low polynomial-time algorithm for rewriting X_{reg} queries on a view into the MFA-presentation of equivalent X_{reg} queries on the source, and (b) a linear-time algorithm for directly evaluating the MFA-presentation of X_{reg} queries on the source.

While a regular expression can be efficiently represented as a graph or a NFA, for X_{reg} queries a notion of automaton representation is not yet available. The difficulties of characterizing an X_{reg} query Q as an automaton include the following: (a) Q typically involves both “selecting” paths that are to extract and return nodes, and filters that constrain the extraction; (b) a filter [q] in Q may involve Boolean operators “̂, [symbol] , [symbol] ” and constant test p/text( )=c′, which are not encountered in regular expressions; (c) worse still, it may be nested: q itself may be a query of the form p[q₁]; and (d) the sub-query p of p* may itself contain Kleene closure.

Mixed Finite State Automata (MFA)

An MFA M is defined as a nondeterministic finite automaton (NFA) in which a state may be annotated with an alternating finite state automaton (AFA). Intuitively, the NFA in M is to capture the selecting paths of an X_{reg} query Q and the AFA's are to characterize the filters in Q.

Formally, an MFA M is defined to be (Nₛ, A), where (a) A is a set of bindings Xᵢ=Aᵢ^{FA}, Xᵢ is a name and Aᵢ^{FA} is an AFA as defined below; (b) Nₛ=(Kₛ, Σₛ, δₛ, s, F, λ) is a variation of NFA, referred to as the selecting NFA of M, where Kₛ, Σₛ, δₛ, s, F are the states, alphabet, transition function, start state and final states as in the standard NFA definition; and λ is a partial mapping from Kₛ to names Xᵢ, i.e., a state in Nₛ may be annotated with a single Xᵢ.

A variation of AFA's is employed to represent X_{reg} filter's. An AFA A^{FA} is defined to be (K, Σ, δ, s, F), where (a) K is a set of states partitioned into Kₒₚ, Kᵢ and F, where Kₒₚ is a set of operator states marked with AND, OR or NOT, Kᵢ is a set of transition states, and F is a set of final states optionally annotated with predicates of the form text( )=‘c’ or position( )=k; (b) Σ is a set of labels; (c) s is the start state in K; and (d) δ is the transition function defined as follows. (1) For a state s₁ in Kₒₚ, δ is only defined for empty string ε and δ(s₁,ε)=K′, where K′ is a subset of K. In particular, if s₁ is marked with NOT, K′ has a single state in it (2). For each state s₂ in K₁, δ is only defined for a single label AεΣ and δ(s₂,A) contains a single state in K. (3) δ is not defined for any state in F. Observe that except for operator states marked with AND or OR, from each state at most one state can be reached via δ. These operator states capture Boolean operators ̂, [symbol] and [symbol] in X_{reg} filters.

### EXAMPLE 4.1

Consider an X_{reg} query Q₀ posed on an XML tree conforming to the DTD of FIG. 1(b), which is to find all patients who have an ancestor diagnosed with heart disease:

Q₀=(patient/parent*/patient[q₀])

q₀(parent/patient)*/record/diagnosis[text( )=“heart disease”┘

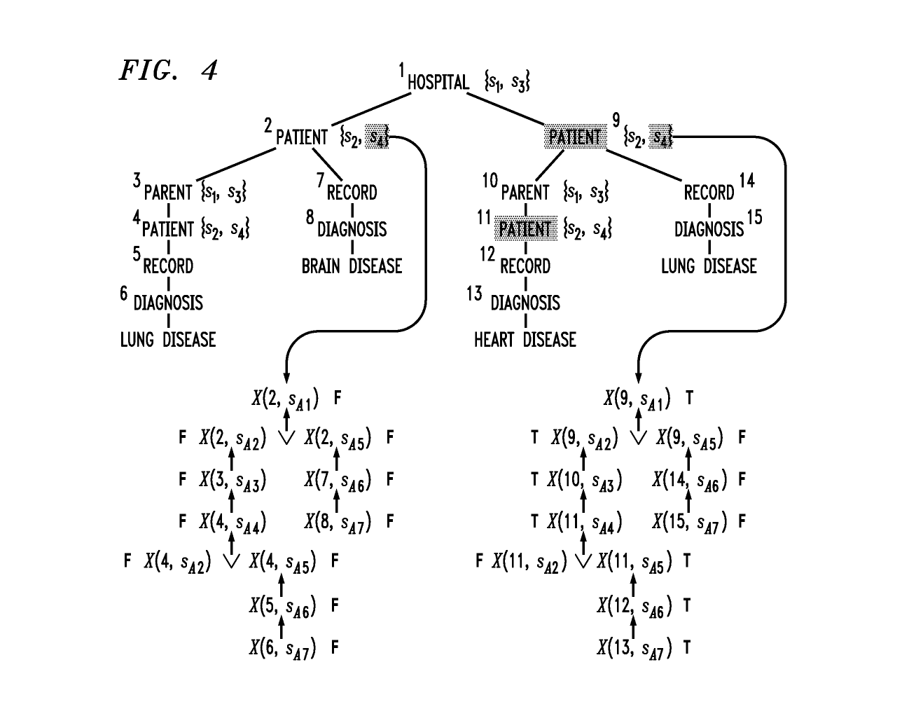

Consider MFA M₀ in FIG. 3. It consists of a selecting NFA Nₛ (shown at the top of the figure), and an AFA A₀^{FA}, corresponding to the filter q₀ (shown at the bottom). The MFA M₀ is equivalent to Q₀, in the sense that when evaluating M₀ at a node n in an XML tree T (described below), it returns the same set n[[M₀]] of nodes as n[[Q₀]].

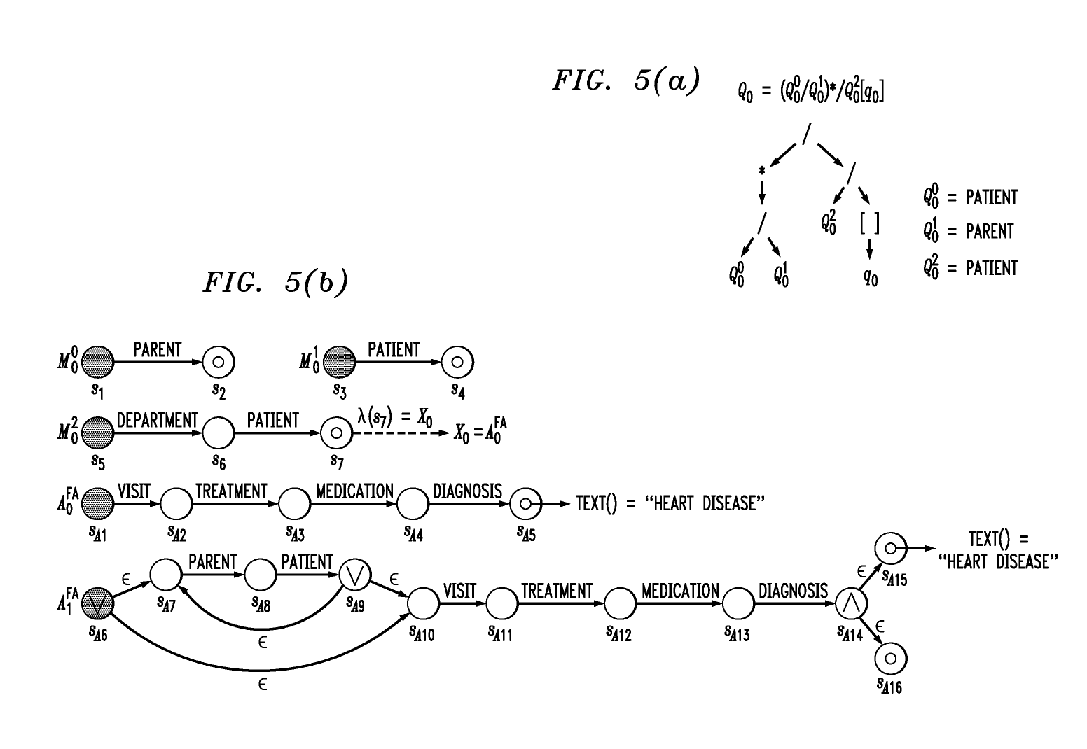

The (conceptual) evaluation of M₀ is illustrated, by example, in FIG. 4. At the root node 1 of the tree, M₀ associates a set {s₁, s₃} of Nₛ states, where s₁ is the start state of Nₛ and s₃ is reached from s₁ via an ε-transition. It then inspects the children of node 1: for all its children labeled patient (nodes 2 and 9), it associates them with states s₂, s₄, moves down to these children and processes them inductively, in parallel. At a node associated with state s₂, for all its children labeled patent (nodes 3 and 10) it associates them with states s₁, s₃ and processes them in the same way as at the parent node of the tree. In the case of state s₄, since this state is annotated with A₀^{FA}, any node associated with state s₄ must also evaluate A₀^{FA} (the evaluation of A₀^{FA} is described below). This is the case for both nodes 2 and 9. Since s₄ is a final state, if A₀^{FA} evaluates to true, the corresponding node is added to n[[M₀]] (the answer of M₀).

When the AFA A₀^{FA} is invoked, e.g., at node 2, a Boolean value 2[[A₀^{FA}]] is computed as follows: A₀^{FA} associates a Boolean variable X(2, s_{AI}) with node 2, whose value is to be computed and treated as 2[[A₀^{FA}]], where s_{A1} is the start state of A₀^{FA}. It then traverses the subtree rooted at node 2 top-down. From s_{A1} there are two ε-transitions to s_{A2} and s_{A5}, and thus node 2 is also associated with variables X(2,s_{A2}) and X(2,s_{A5}) for these AFA states. Since s_{A1} is an OR state, X(2,s_{A1}) is computed via X(2,s_{A2}) [symbol] X(2,s_{A5}). To compute X(2,s_{A5}), it inspects the children of node 2: if no child is labeled record, no A₀^{FA} transition can be made from s_{A5} and X(2,s_{A5}) is assigned false; otherwise, for all children labeled record, in this case node 7, it associates a variable X(7,s_{A6}), moves down to these children and process them in parallel. Inductively, X(7,s_{A6}) is true if node 7 has a child labeled diagnosis and carrying text “heart disease”, and if so, X(2,s_{A5}) is assigned true as well. Similarly, X(2,s_{A2}) is computed and becomes true if it has a descendant that is reachable via (parent/patient)*/record/diagnosis and carries text “heart disease”. If either X(2,s_{A2}) or X(2,s_{A5}) is true, then X(2,s_{A1}) is true and so is the output 2[[A₀^{FA}]]. This is not the case here, however, and A₀^{FA} returns false.

Observe the following. (a) Although A₀^{FA} traverses the subtree top-down, the Boolean variables are computed bottom-up. (b) In A₀^{FA} the only operator states ate OR states (s_{A}_{₁}, s_{A4}); but AND and NOT states can be processed similarly. (c) The conceptual evaluation requires multiple passes over a subtree, one pass for each filter. In contrast, the disclosed evaluation algorithm requires only one pass of the input tree, regardless of the number of filters.

Equivalence of MFA and X_{reg} Queries

An MFA M and an X_{reg} query Q are equivalent if for each XML tree T and any node n in T, n[[M]]=n[[Q]], where n[[M]] (resp. n[[Q]]) denotes the result of evaluating an MFA M (resp. Q) at n.

The result below tells us that a class of MFA's can be identified, namely, MFA's with a syntactic restriction on AFA's called the split property, to precisely capture the fragment X_{reg} of regular XPath queries; as a result, MFA's can be used to represent X_{reg} queries.

For any X_{reg} query Q, there exists an equivalent MFA M with the split property, and vice versa.

### Rewriting Algorithm

A rewrite algorithm is employed for rewriting (regular) XPath queries on arbitrary views into equivalent MFA's on the underlying documents. Generally, algorithm rewrite takes as input an X_{reg} query Q and a view definition σ:D→D_{V}; it returns an MFA M=(Nₛ, A) as output, such that for any XML tree T of D, M on T yields the same result as Q on σ(T). It is based on dynamic programming: for each sub-query Q′ of Q and each element type A in D_{V}, it computes a local translation rewr(Q′, A), i.e., an MFA on D that is equivalent to Q′ when Q′ is evaluated at any A elements of D_{V}. The MFA rewr(Q′, A) is constructed inductively, based on structure of Q′. It assembles local translations to obtain M=rewr(Q,r), where r is the root type of D_{V}.

### EXAMPLE 5.1

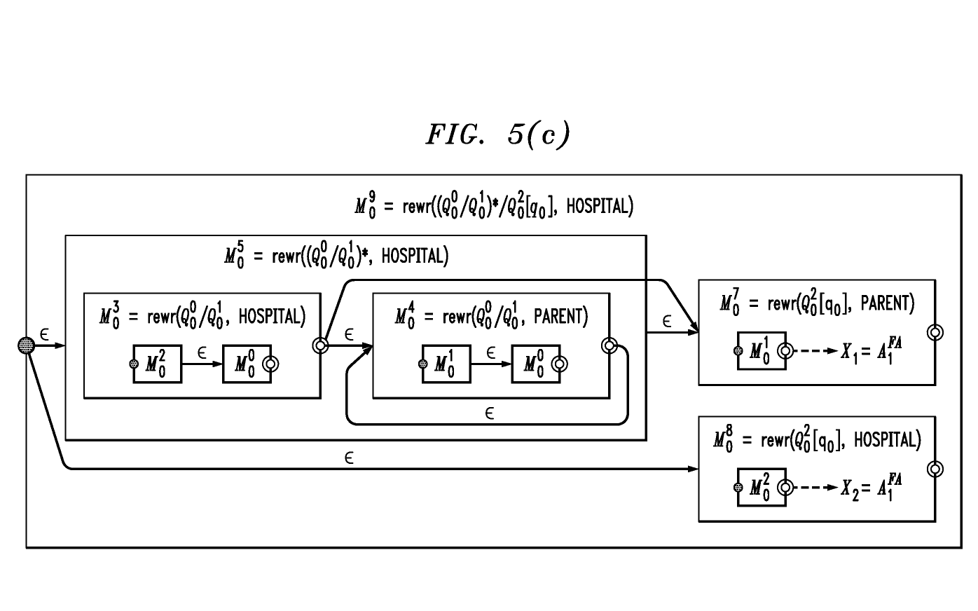

Given query Q₀ of Example 4.1 on the view σ₀ of Example 2.2, assume that it is desired to compute rewr(Q₀,hospital). FIG. 5(a) shows a simplified parse tree of Q₀. Algorithm rewrite uses this parse tree to inductively build the MFA for Q₀. In more detail, FIG. 5(b) shows three MFA s and two AFA s that are the basis of the induction of the rewriting of Q₀. Specifically, M₀⁰ corresponds to rewr(parent,patient), M₀¹ to rewr(patient,parent) and M₀² to rewr(patient,hospital). Notice that the construction of M₀² also requires the construction of A₀^{FA}.

FIG. 5(c) illustrates how Algorithm rewrite uses these basic blocks to build inductively the MFA rewr(Q₀,hospital). Specifically, algorithm rewrite constructs M₀³=rewr(Q₀⁰/Q₀¹hospital) by concatenating MFA M₀² and M₀⁰. Then, algorithm rewrite constructs M₀⁵=rewr((Q₀⁰/Q₀¹)*, hospital) by concatenating M₀³ with M₀⁴=rewr(Q₀⁰/Q₀¹,parent) and adding appropriate ε-transitions for the recursion. Finally, the algorithm considers the rewriting of Q₀²[q₀] and concatenates this to MFA M₀⁵ to compute the final result.

Similarly, rewrite constructs AFA's for filters q, with the following features. (a) For a “path sub-queries” Q′ (i.e., of the form p given above) of q, rewrite defines its AFA in same way as MFA for Q′. (b) For logical connectives ̂, [symbol] , or [symbol] , rewrite connects inductively obtained AFA's by introducing a new logical state, i.e., an AND, OR, or NOT state. (c) For nested filters, i.e., q=p[q₁] where q₁=p′[q_{1′}], rewrite constructs a single AFA, rather than nested AFA's, for q, by “concatenating” the AFA's for p and q₁.

### EXAMPLE 5.2

Consider the filter q₀ in the query Q₀ of Example 4.1. FIG. 5(b) shows how its AFA A₁^{FA} is constructed step-wise, by reusing the MFA's M₀⁰,M₀¹,M₀² for path sub-queries, and by concatenating these and “local” AFA's to build A₀^{FA} and A₁^{FA}. Note that although q₀ contains a nested filter text( )=‘heart disease’, the two filters are combined into a single AFA and no “nested” AFA's are required.

Given a view definition σ:D→D_{V} and an X_{reg} query Q over D_{V}, Algorithm rewrite computes an equivalent MFA of size at most O(|Q∥σ∥D_{V}|) over the original document in at most O(|Q|²|σ∥D_{V}|²) time.

### Evaluation Algorithm

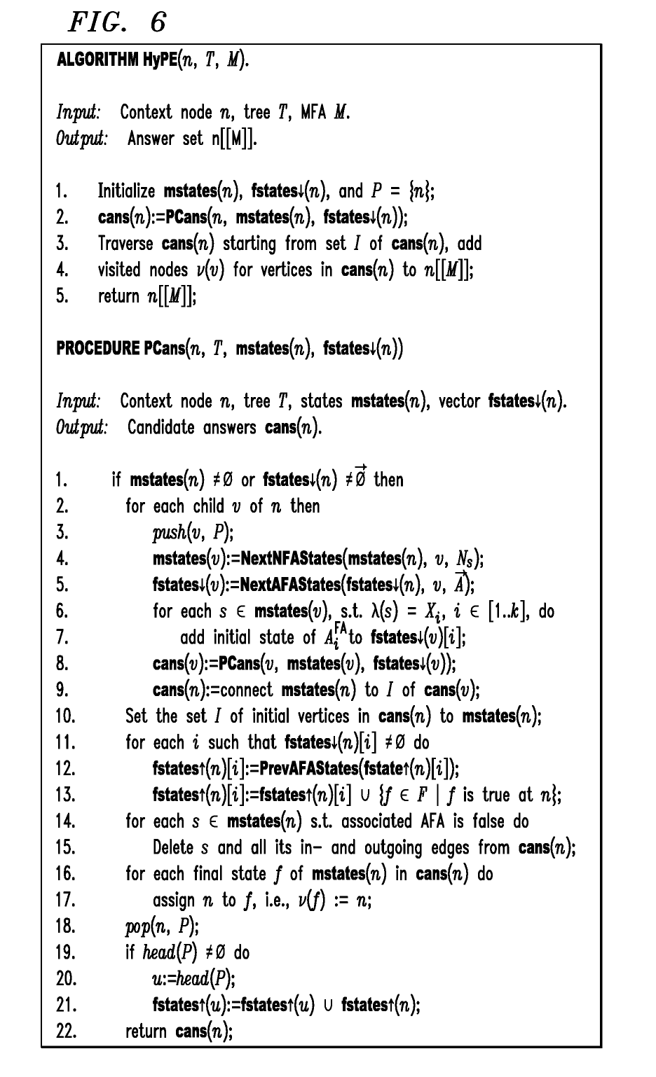

To make query rewriting a practical approach, it is necessary to efficiently evaluate MFA's. An evaluation algorithm for MFA's is presented, referred to as HyPE (Hybrid Pass Evaluation, FIG. 6). Algorithm HyPE takes as input a document tree T, a context node n in T and an MFA M=(Nₛ,A); it outputs n[[M]]. The desired result r[[M]] is obtained by invoking HyPE with the root r of T.

A salient feature of HyPE is that it requires only a single top-down pass over the document tree, and a single pass over an auxiliary structure, which in most cases is much smaller than the document tree. It employs several pruning strategies in its top-down pass to avoid visiting irrelevant parts of the tree and the computation of irrelevant AFA's.

Since any regular XPath query can be transformed into an MFA, HyPE serve as a stand-alone evaluation algorithm for regular XPath, beyond the rewriting context. There are no known practical algorithms that can be done within a bounded number of tree traversals. For XPath only, a two-pass algorithm was presented in C. Koch, “Efficient Processing of Expressive Node-Selecting Queries on XML. Data in Secondary Storage: A Tree Automata-Based Approach,” VLDB (2003), a bottom-up phase for evaluating filters followed by a top-down phase for selecting nodes. However, it requires a pre-processing step (another scan of the tree) during which the document tree is converted to a special data format (a binary representation of the tree), and the construction of a tree automata which are more complex than MFA's and are possibly large Algorithm HyPE requires neither pre-processing of the data nor the construction of tree automaton. Moreover, in contrast to HyPE, the two-pass XPath evaluation algorithm may have to evaluate filters at nodes in its first phase, although these nodes will not be accessed in its second phase. It has been found that the pruning technique of HyPE speeds up the evaluation of both regular XPath and XPath queries.

Generally, HyPE consists of two phases (not to be confused with two passes of the tree T). In the first phase, the tree T is traversed (top-down) depth-first, during which the MFA M prunes away irrelevant subtrees and identifies which AFA's in A need to be evaluated at nodes in the tree. Visited nodes are pushed into a stack P. This stack is used to evaluate the AFA's in a synthesized (bottom-up) way. A node is popped from P once all its related AFA's have been evaluated. The size of P is at most the depth of T. During this traversal, HyPE also constructs an auxiliary DAG structure, called cans (for candidate answers), representing the history of the run of the selecting NFA Nₛ. Vertices in cans will correspond to states in this run for which the associated AFA evaluated to true. Moreover, vertices in cans are possibly annotated with a node in T which is potentially in the answer set n[[M]]. A node in T associated with a vertex in cans will be in n[[M]] if this node is reachable from a node in cans corresponding to an initial state of Nₛ at context node n. This allows for distinguishing between potential and real answer nodes in cans. In the second phase, cans is traversed top-down to identify the real answer nodes. The size of cans is typically much smaller than T.

### EXAMPLE 6.1

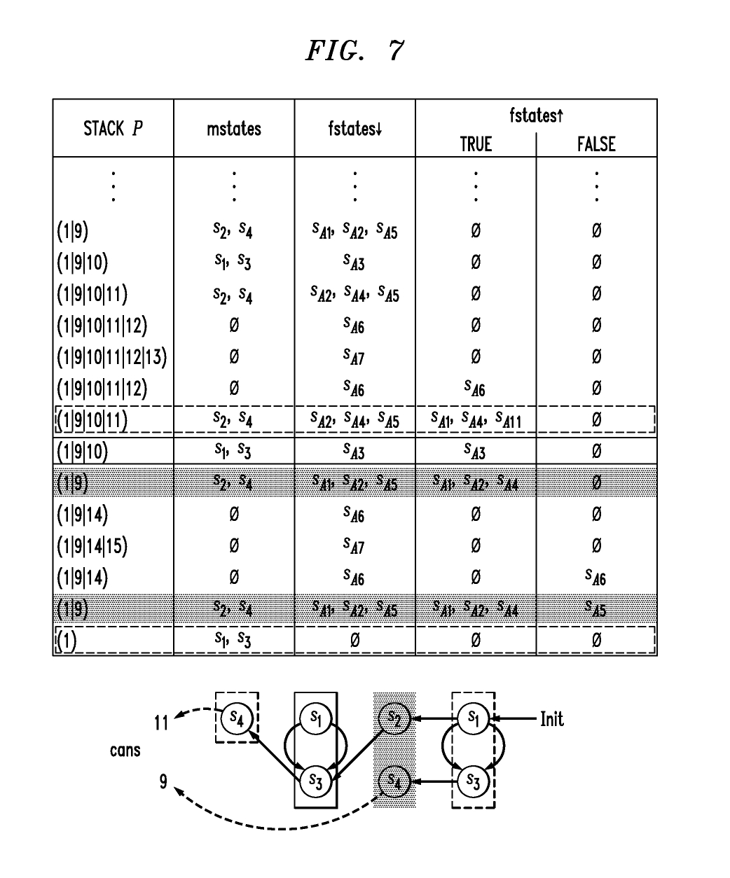

Consider the MFA M₀ in FIG. 3 and the tree T shown in FIG. 4 HyPE evaluates M₀ on T as shown in the table of FIG. 7. In FIG. 7, it is assumed that HyPE has already traversed, top-down, the left-most patient (node 2) in the tree and the execution of HyPE is joined at the point where node 9 is considered (the first row in the table). Each row in the table corresponds to a step in the execution of HyPE during which the node n at the head of the stack P is considered. The table in FIG. 7 also shows (a) mstates(n), i e., the ε-closure of states in Nₛ (i.e., the set of states reached by following one or more ε moves), reached by descending to n in T; (b) fstates (n), i.e., a set of states in A₀^{FA}. If this set is non-empty then n will be involved in the bottom-up evaluation of A₀^{FA}; and (c) fstates (n), i.e., a set of states (and their truth values) of A₀^{FA} used in the bottom-up evaluation of A₀^{FA}. The bottom of FIG. 7 shows the auxiliary structure cans. It is constructed during the traversal of T. FIG. 7 indicates, through boxes, which rows in the table are responsible for the corresponding updates to cans (note that cans is constructed from left to right in FIG. 7).

Referring again to FIG. 7, the first row of the table indicates two things. First, since s₄ is a final state of Nₛ, node 9 is a candidate answer. Second, state s₄ is annotated with A₀^{FA} and therefore A₀^{FA} needs to be evaluated to determine whether node 9 is an actual answer. It is remembered that A₀^{FA} needs to be evaluated on node 9 by initializing fstates (9) with the initial states of A₀^{FA}. Consider now the second row in the table Node 10 is in the top of P. Furthermore, mstates(10) is {s₁,s₃} and is obtained by calling function. NextNFAStates with arguments the mstates(9)={s₂,s₄} (line 4 in algorithm of FIG. 6). Similarly, NextAFAStates computes fstates (10)={s_{A3}} from fstates (9) (line 5 in FIG. 6). The fact that fstates (10) is non-empty tells us that node 10 is relevant for the evaluation of A₀^{FA}. The actual evaluation of A₀^{FA} starts when in the head of P is node 13. At that point, fstates (13) includes the final state of A₀^{FA} and from that point on A₀^{FA} is evaluated bottom-up. This hybrid mixing of a top-down with a bottom-up evaluation is the distinguishing characteristic of HyPE. Essentially, HyPE uses the former evaluation type to determine when to initiate the latter. When HyPE returns to P={1,9} (the dark grey row of the table), the fact that fstates (9) includes {s_{A1}=true} indicates that the evaluation of A₀^{FA} results in true. Therefore, node 9 is an actual answer. Concerning cans, this is constructed bottom-up. For each node n for which mstates(n)≠Ø, mstates(n) is connected to the existing cans, each time the subtree below a child of n has been traversed. For example, when P={1,9} (dark gray row), mstates(9) is connected (using the transitions in M₀) to the cans structure to its left. At this point, notice that by following the path s₂, s₃, s₄ node 11 is reached in T. Furthermore, through the new state s₄ node 9 is also reachable. When the construction of cans completes done (row with dashed box), a traversal of cans starting from the Init nodes shows that nodes 9 and 11 are still reachable and hence are in the answer of M₀ on T.

Complexity

The complexity of HyPE is determined by that of PCans (for constructing cans) and the traversal of cans. PCans needs for each context node n at most O(|M|) time. Moreover, connecting and updating cans takes at most O(|M|) time as well. Hence, the overall time complexity of PCans is O(|T∥M|). Moreover, PCans requires a single scan of the input document T and cans. The space requirement of PCans is dominated by the size of cans, which, although in the worst case is O(|T∥M|), is typically much smaller than |T|. Traversing cans takes again O(|T∥M|) time in the worst case. As a consequence:

Given an MFA M and tree T, HyPE computes r[[M]] in at most O(|T∥M) time and space. Using the evaluation algorithm together with the rewriting algorithm, a practical method is obtained for answering queries on (virtual) views.

Given an X_{reg} query Q on a view of an XML source T, the disclosed query answering method returns the answer to Q in O(|Q|²|σ∥D_{V}|²+|Q∥σ∥D_{V}∥T|) time.

The size |T| of the document is dominant and is typically much larger than the size |D_{V}| of the view DTD and the size |σ| of the view definition σ; when only |T| is concerned (e g., if D_{V} and σ are fixed as commonly encountered in practice), the disclosed method answers queries in linear-time (data complexity), and in quadratic combined complexity.

An index structure can be employed to enable HyPE to skip even more subtrees.

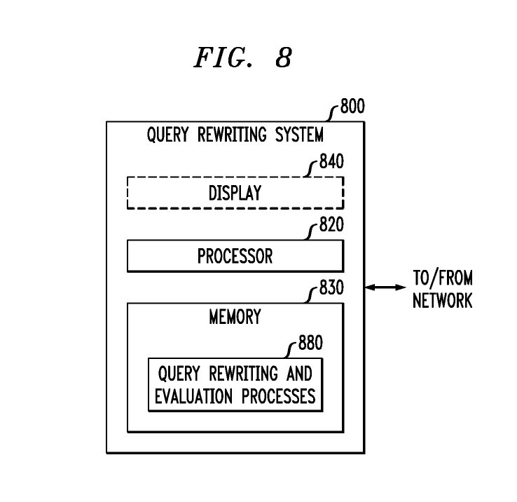

FIG. 8 is a block diagram of a system 800 that can implement the processes of the present invention. As shown in FIG. 8, memory 830 configures the processor 820 to implement the query rewriting and evaluation methods, steps, and functions disclosed herein (collectively, shown as 880 in FIG. 8). The memory 830 could be distributed or local and the processor 820 could be distributed or singular. The memory 830 could be implemented as an electrical, magnetic or optical memory, or any combination of these or other types of storage devices. It should be noted that each distributed processor that makes up processor 820 generally contains its own addressable memory space. It should also be noted that some or all of computer system 800 can be incorporated into an application-specific or general-use integrated circuit.

System and Article of Manufacture Details

As is known in the art, the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, or memory cards) or may be a transmission medium (e g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk.

The computer systems and servers described herein each contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

It is to be understood that the embodiments and variations shown and described herein are merely illustrative of the principles of this invention and that various modifications may be implemented by those skilled in the art without departing from the scope and spirit of the invention.

We claim:

1. A method for processing a view query on a database view, said method comprising:
translating said view query to a mixed finite state automata representation of a document query on one or more documents underlying said database view; and
evaluating said document query on said one or more documents to obtain a result to said view query.

2. The method of claim 1, wherein said view query is a regular XPath query.

3. The method of claim 1, wherein said mixed finite state automata is a nondeterministic finite automaton in which a state may be annotated with an alternating finite state automaton.

4. The method of claim 3, wherein said nondeterministic finite automaton captures selecting paths of said view query that extract and return nodes from said database.

5. The method of claim 3, wherein said alternating finite state automaton characterizes filters in said view query that constrain an extraction of nodes from said database.

6. The method of claim 1, wherein said database is an XML document.

7. The method of claim 1, wherein said translating step further comprises the step of generating one or more local translations for one or more sub-queries for said view query and one or more element types in said database view.

8. The method of claim 1, wherein said evaluating step further comprise the steps of traversing a tree associated with said one or more documents using a top-down, depth-first analysis, wherein said mixed finite state automata prunes away one or more irrelevant subtrees and identifies one or more alternating finite state automata that need to be evaluated at nodes in said tree.

9. The method of claim 8, further comprising the step of storing visited nodes from said tree in a stack, wherein said stack is used to evaluate said alternating finite state automata in a synthesized, bottom-up manner and wherein a node is removed from said stack once said alternating finite state automata related to said node have been evaluated.

10. The method of claim 8, further comprising the step of generating an auxiliary data structure that stores one or more candidate answers.

11. The method of claim 8, further comprising the step of maintaining an index structure that allows one or more subtrees to be skipped.

12. A system for processing a view query on a database view, said sysem comprising:
a memory; and
at least one processor, coupled to the memory, operative to:
translate said view query to a mixed finite state automata representation of a document query on one or mole documents underlying said database view; and
evaluate said document query on said one or more documents to obtain a result to said view query.

13. The system of claim 12, wherein said view query is a regular XPath query.

14. The system of claim 12, wherein said mixed finite state automata is a nondeterministic finite automaton in which a state may be annotated with an alternating finite state automaton.

15. The system of claim 14, wherein said nondeterministic finite automaton captures selecting paths of said view query that extract and return nodes from said database and wherein said alternating finite state automaton characterizes filters in said view query that constrain an extraction of nodes from said database.

16. The system of claim 12, wherein said processor is further configured to translate said view query by generating one or more local translations for one or more sub-queries for said view query and one or more element types in said database view.

17. The system of claim 12, wherein said processor is further configured to evaluate said document query by traversing a tree associated with said one or more documents using a top-down, depth-first analysis, wherein said mixed finite state automata prunes away one or more irrelevant subtrees and identifies one or more alternating finite state automatons that need to be evaluated at nodes in said tree.

18. The system of claim 19, wherein said processor is further configured to store visited nodes from said tree in a stack, wherein said stack is used to evaluate said alternating finite state automatons in a synthesized, bottom-up manner and wherein a node is removed from said stack once said alternating finite state automata related to said node have been evaluated.

19. The system of claim 19, wherein said processor is further configured to generate an auxiliary data structure that stores one or more candidate answers.

20. An article of manufacture for processing a view query on a database view, comprising a machine readable medium containing one or more programs which when executed implement the steps of:
translating said view query to a mixed finite state automata representation of a document query on one or more documents underlying said database view; and
evaluating said document query on said one or more documents to obtain a result to said view query.
